(19) United States
(12) Patent Application Publication
(10) Pub. No.: US 2012/0154535 A1
(43) Pub. Date: Jun. 21, 2012

(54) CAPTURING GATED AND UNGATED LIGHT IN THE SAME FRAME ON THE SAME PHOTOSURFACE

(75) Inventors: Giora Yahav, Haifa (IL); Shlomo Felzenshtein, Haifa (IL); Eli Larry, Haifa (IL)

(73) Assignee: MICROSOFT CORPORATION, Redmond, WA (US)

(21) Appl. No.: 12/968,775

(22) Filed: Dec. 15, 2010

(51) Int. Cl. H04N 13/02; H04N 5/335

(52) U.S. Cl. 348/46; 348/308; 348/E13.074; 348/E05.091

(57) ABSTRACT

A photosensitive surface of an image sensor, hereafter a photosurface, of a gated 3D camera is controlled to acquire both gated and ungated light in the same frame on different areas of its surface. One image capture area of the photosurface acquires gated light during a gated period while another image capture area is OFF for image data capture purposes. During an ungated period, the other image capture area of the same photosurface captures ungated light as image data. Typically, the gated and ungated periods are interleaved during the same frame period.

### CROSS REFERENCE TO RELATED APPLICATION

The patent application incorporates by reference U.S. patent application Ser. No. 12/699,074 entitled “Fast Gating Photosurface” having inventors Giora Yahav, Shlomo Felzenshtein and Eli Larry filed Feb. 3, 2010.

### BACKGROUND

Gated three-dimensional (3D) cameras, for example time-of-flight (TOF) cameras, provide distance measurements to objects in a scene by illuminating a scene and capturing reflected light from the illumination. To capture light is to receive light and store image data representing the light. The distance measurements make up a depth map of the scene from which a 3D image of the scene is generated.

The gated 3D camera includes a light source for illuminating the scene typically with a train of light pulses. The gated 3D camera further comprises an image sensor with a photosensitive surface, hereinafter referred to as a “photosurface.” The photosurface comprises photosensitive or light sensitive sensors conventionally referred to as pixels and storage media for storing the image data sensed.

In some gated 3D cameras, distance measurements are based only on whether light is captured on the camera's photosurface, and the time elapsed between light transmission and its reflection from the scene captured by the photosurface. In other gated 3D cameras, an amount of light, referred to as gated light, is captured by the photosurface and is generally corrected for reflectivity of the object, dark current and background light through normalization with other measurements called ungated light which capture a total amount of reflected light from the object. In one example, the normalization divides the gated measurements by the ungated measurements to create normalized gated light measurements which are used for the depth map.

For determining distances to moving objects capturing gated and ungated light close together in time improves accuracy of distance measurements. Conventionally, two photosurfaces have been used to reduce delay time. One photosurface acquires gated light while the other photosurface, substantially simultaneously, acquires ungated light.

In other instances, gated and ungated light are captured in different frames of a same photosurface causing a delay time at least equal to a frame readout time period. For moving objects in a scene, the delay between acquisition times of frames of gated and ungated light can result in a “mismatch”, in which a same light sensitive pixel of the photosurface captures gated and ungated light from different objects in the scene rather than a same object, or from a same object at different distances from the camera. The mismatch generates error in a distance measurement determined from images that the pixel provides.

### SUMMARY

Technology is provided for controlling a photosurface, of an image sensor to capture gated and ungated light from a scene in a same frame period of the photosurface. One embodiment of the technology provides a system comprising the photosurface of the image sensor which includes at least a first image capture area on its surface and at least a second image capture area on the same photosurface. During a gated period when gated light is being captured, the second image capture area is in an OFF state in which image data is not captured meaning received and stored. Control circuitry controls capture of gated light by the first image capture area during this period. During an ungated period when ungated light is being captured, the first image capture area is in the OFF state and the control circuitry controls capture of ungated light by the second image capture area during this period. In another system embodiment, the image capture area includes respective sets of lines of light sensing pixel elements, hereafter referred to as photopixels, and respective image data storage media for storing as image data the light sensed by the photopixels.

Typically, the gated and ungated periods are interleaved during the same frame period which further minimizes acquisition delay between gated and ungated light for the same object in motion in a scene. Another embodiment of the technology provides a method for capturing interleaved gated and ungated light from a scene in a same frame period on the same photosurface. In an embodiment of a method, the gated light is captured by a first image capture area during a gated period having a duration less than or equal to 10 microsecond while the second image capture area is turned to the OFF state. Similarly, the method captures the ungated light by a second image capture area during an ungated period having a duration or about equal to 10 microseconds. The photosurface is controlled to alternate within 1 or 2 microseconds the capturing of gated light and the capturing of ungated light.

Embodiments of the technology also gate a respective capture area of the photosurface between the ON state and the OFF state while the area is capturing light within the respective gated or ungated period. As mentioned previously, a train of light pulses can be used to illuminate the scene. The gated period comprises one or more short capture periods also called gates. In one embodiment, each short capture period is set to last about a pulse width of a light pulse. An example pulse width can be 10 or 20 ns. Similarly, the ungated period comprises one or more long capture periods, and each long capture period is longer than each short capture period. During the ungated period, the image capture area for ungated light tries to capture all the light reflected from the pulses by a scene that reaches the ungated image capture area for normalization of the gated light image data. In the example of a 10 ns pulse width for a short capture period, the corresponding long capture period may be about 30 ns. Likewise for a 20 ns pulse width example, the corresponding long capture period may be about 60 ns.

The technology can operate within a 3D camera, for example a 3D time-of-flight camera.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology for controlling a photosurface to capture gated and ungated light from a scene in a same frame period in accordance with this specification are further described with reference to the accompanying drawings.

FIG. 1 illustrates an example embodiment of a target recognition, analysis, and tracking system in which embodiments of the technology can operate.

FIG. 2 shows a block diagram of an example of a capture device that may be used in the target recognition, analysis, and tracking system in which embodiments of the technology can operate.

FIG. 3 schematically shows an embodiment of a gated 3D camera which can be used to measure distances to a scene.

FIG. 4 illustrates an example of a system for controlling a photosurface of an image sensor including at least two image capture areas, one for use during a gated period, and the other for use during an ungated period.

FIG. 5 is a flowchart of an embodiment of a method for capturing interleaved gated and ungated light from a scene in a same frame period on the same photosurface.

FIG. 6A schematically shows a highly simplified cross sectional view of a portion of an interline charge coupled device (CCD) photosurface embodiment during a long capture period of an ungated period.

FIG. 6B schematically shows the highly simplified cross sectional view of the portion of the interline CCD photosurface embodiment of FIG. 6A in a period outside a long capture period and within the same ungated period.

FIG. 7 illustrates a system embodiment for controlling a complementary metal oxide silicon (CMOS) photosurface including at least two image capture areas, one for capturing light during a gated period, and the other for capturing light during an ungated period.

FIG. 8A is a top planar view illustrating an embodiment of an architecture of a basic unit cell including charge sensing elements from which CMOS photogate pixels are formed.

FIG. 8B is a cross-sectional view of one of the charge sensing element embodiments across the X-X line in FIG. 8A.

FIG. 8C is a cross-sectional view of one of the charge sensing element embodiments across the Y-Y line in FIG. 8A.

FIG. 8D illustrates an example of cell control and readout circuitry for use with the basic unit cell embodiment of FIG. 8A.

FIG. 9 is a schematic illustration of an embodiment of a basic pixel building block comprising two basic unit cells.

FIG. 10 is an exemplary timing diagram for the basic unit cell embodiment of FIG. 8A.

### DETAILED DESCRIPTION

A photosurface, captures both gated and ungated light on different capture areas of its surface during a same frame period. As shown in the embodiments below, time delay between periods of imaging gated light and periods of imaging ungated light is substantially less than a time required to acquire a frame. For example, in some embodiments, the delay is on the order of about a microsecond while the frame period is on the order of milliseconds (ms). For example, a typical frame period is 25 to 30 ms while the transition delay between a gated period and an ungated period can be about 1 or 2 microseconds, and each gated and ungated period about 10 microseconds.

The photosurface comprises at least two image capture areas, one for capturing gated light, and one for capturing ungated light. An image capture area can take many shapes and forms. For example, an image capture area can be a set of lines in an interline CCD. In other embodiments, the capture area can take different geometries, for example hexagons, squares, rectangles and the like.

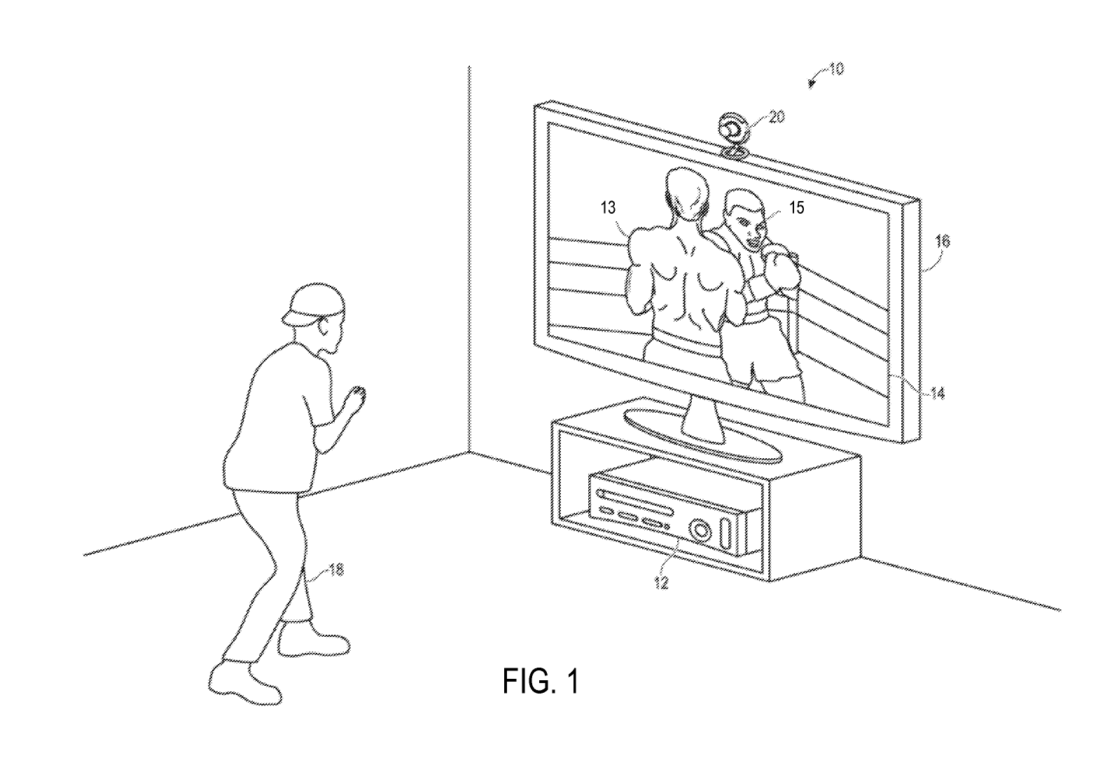

Tracking moving targets in 3D is a typical application of gated 3D cameras. FIG. 1 provides a contextual example in which a fast gating photosurface provided by the present technology can be useful. FIG. 1 illustrates an example embodiment of a target recognition, analysis, and tracking system 10 in which technology embodiments controlling a photosurface to capture gated and ungated light in the same frame can operate. The target recognition, analysis, and tracking system 10 may be used to recognize, analyze, and/or track a human target such as the user 18. Embodiments of the target recognition, analysis, and tracking system 10 include a computing environment 12 for executing a gaming or other application, and an audiovisual device 16 for providing audio and visual representations from the gaming or other application. The system 10 further includes a capture device 20 for capturing positions and movements performed by the user in 3D, which the computing environment 12 receives, interprets and uses to control the gaming or other application.

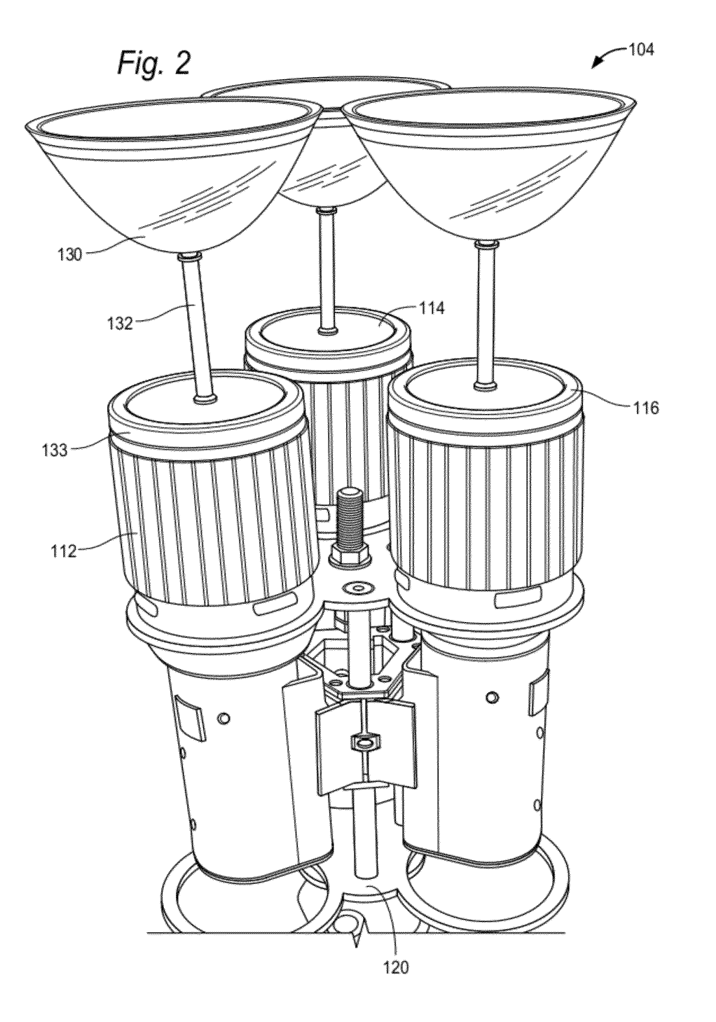

In an example embodiment, the application executing on the computing environment 12 may be a game with real time interaction such as a boxing game that the user 18 may be playing. For example, the computing environment 12 may use the audiovisual device 16 to provide a visual representation of a boxing opponent 15 to the user 18. The computing environment 12 may also use the audiovisual device 16 to provide a visual representation of a player avatar 13 that the user 18 may control with his or her movements. For example, the user 18 may throw a punch in physical space to cause the player avatar 13 to throw a punch in game space. Thus, according to an example embodiment, the capture device 20 captures a 3D representation of the punch in physical space using the technology described herein. A processor (see FIG. 2) in the capture device and the computing environment 12 of the target recognition, analysis, and tracking system 10 may be used to recognize and analyze the punch of the user 18 in physical space such that the punch may be interpreted as a gesture or game control of the player avatar 13 in game space and in real time.

FIG. 2 illustrates a block diagram view of an example of a capture device 20 that may be used in the target recognition, analysis, and tracking system 10. In an example embodiment, the capture device 20 may be configured to capture video having a depth image that may include depth values via any suitable technique including, for example, time-of-flight, structured light, stereo image, or the like. According to one embodiment, the capture device 20 may organize the calculated depth information into “Z layers,” or layers that are perpendicular to a Z axis extending from the depth camera along its optic axis.

As shown in FIG. 2, according to an example embodiment, the image capture device 20 comprises an image camera component 22 which may include an IR light component 24, a three-dimensional (3D) camera 26, and an RGB camera 28 that may be used to obtain a depth image of a scene. For example, the RGB camera may capture a contrast image. In time-of-flight analysis, the IR light component 24 of the capture device 20 may emit infrared light pulses onto the scene and may then use sensors on a photosurface of camera 26 to detect the backscattered light from the surface of one or more targets and objects in the scene to obtain a depth image.

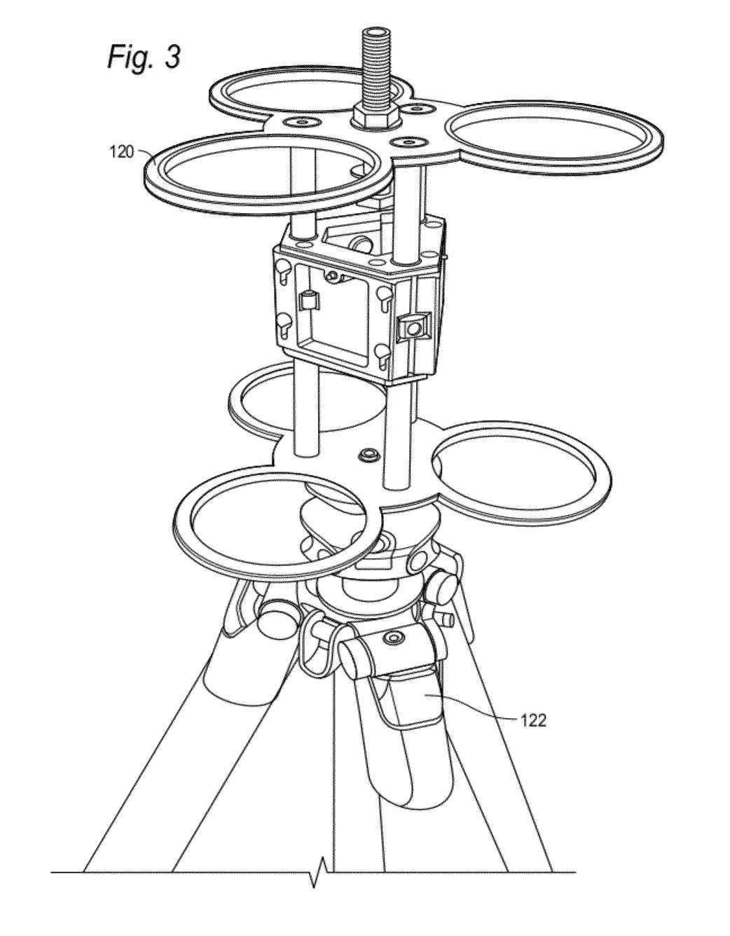

In an example embodiment, the capture device 20 may further include a processor 32 that may be in operative communication with the image camera component 22. The processor 32 may include a standardized processor, a specialized processor, a microprocessor, or the like that may execute instructions for receiving the depth image, determining whether a suitable target may be included in the depth image, converting the image of the suitable target into a skeletal representation or model of the target, or any other suitable instruction. Additionally, as illustrated in FIG. 3, the processor 32 may send start and end of frame messages, which can be hardware, firmware or software signals.

The capture device 20 may further include a memory component 34 that may store the instructions that may be executed by the processor 32, images or frames of images captured by the 3D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image camera component 22 and the processor 32. According to another embodiment, the memory component 34 may be integrated into the processor 32 and/or the image camera component 22.

As shown in FIG. 2, the capture device 20 may communicate with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection.

Additionally, the capture device 20 may provide the depth information and images captured by, for example, the 3D camera 26 and the RGB camera 28, and a skeletal model that may be generated by the capture device 20 to the computing environment 12 via the communication link 36. A variety of known techniques exist for determining whether a target or object detected by capture device 20 corresponds to a human target. Skeletal mapping techniques may then be used to determine various body parts on that user's skeleton. Other techniques include transforming the image into a body model representation of the person and transforming the image into a mesh model representation of the person.

The skeletal model may then be provided to the computing environment 12 such that the computing environment may track the skeletal model and render an avatar associated with the skeletal model. Under the control of gesture recognition engine software 190, the computing environment 12 may further determine which controls to perform in an application executing on the computer environment based on, for example, gestures of the user that have been recognized from three dimensional movement of parts of the skeletal model.

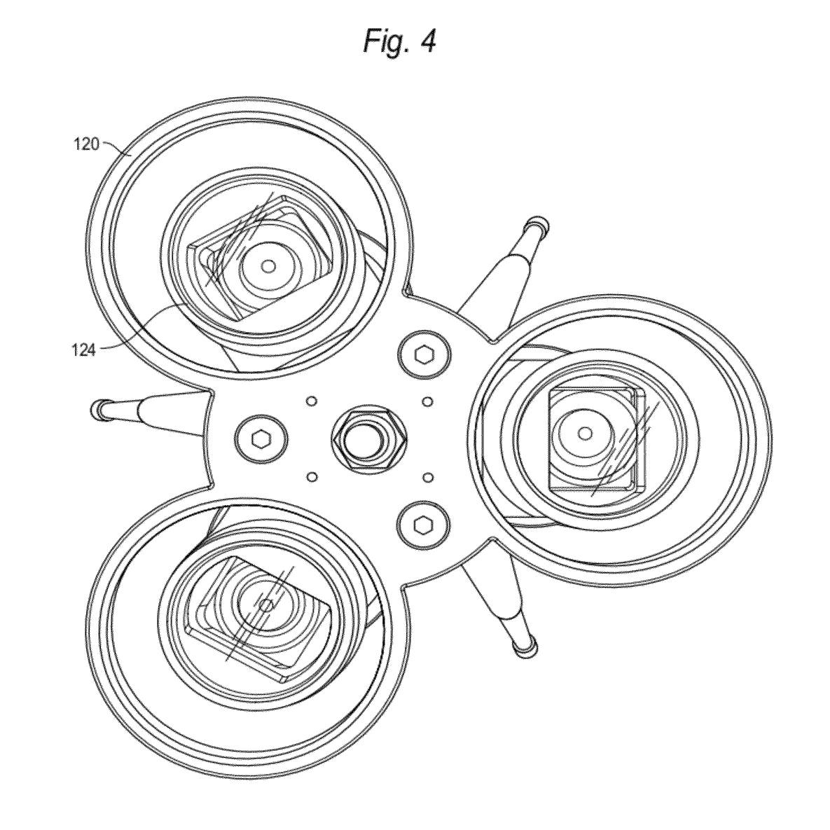

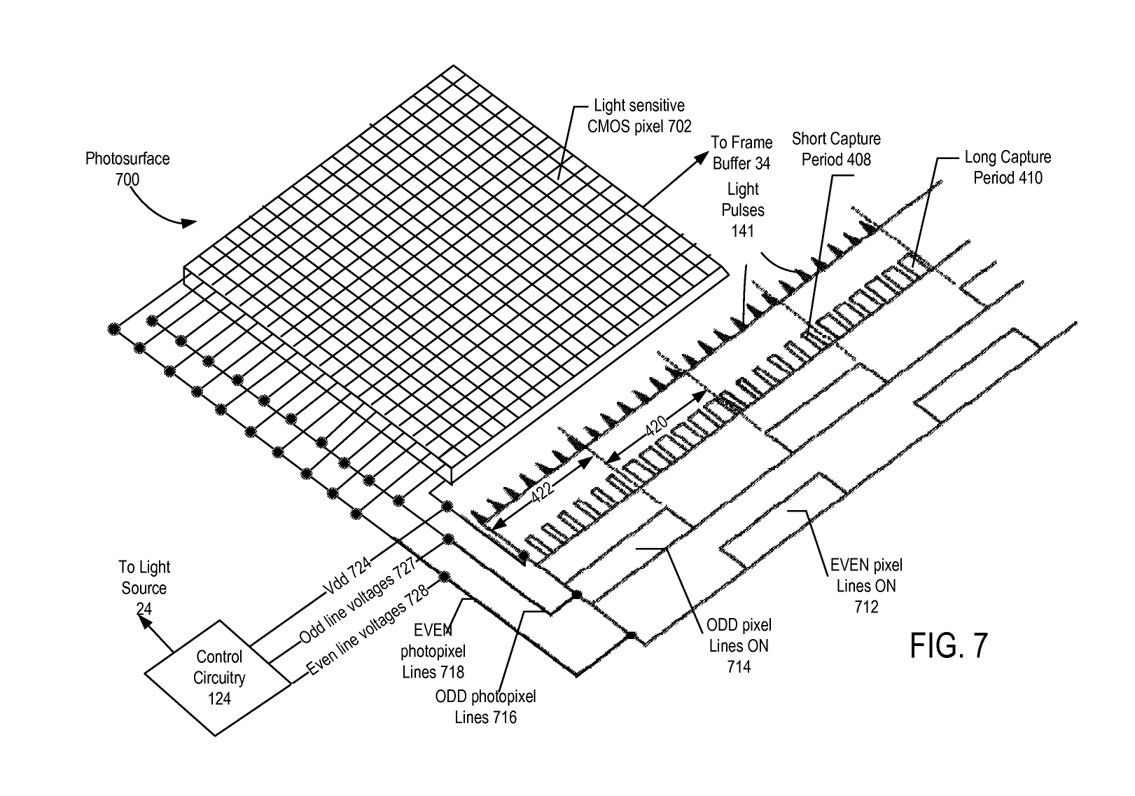

FIG. 3 schematically shows an embodiment of a gated 3D image camera component 22 which can be used to measure distances to a scene 130 having objects schematically represented by objects 131 and 132. The camera component 22, which is represented schematically, comprises a lens system, represented by a lens 121, a photosurface 300 with at least two capture areas on which the lens system images the scene, and a suitable light source 24. Embodiments of different image capture areas are shown and discussed below for a CCD embodiment in FIG. 4 and a CMOS embodiment in FIG. 7. Some examples of a suitable light source are a laser or an LED, or an array of lasers and/or LEDs, that is controllable to illuminate scene 130 with pulses of light by control circuitry 124.

The pulsing of the light source 24 and the gating of different image capture areas of the photosurface 300 is synchronized and controlled by control circuitry 124. In one embodiment, the control circuitry 124 comprises clock logic or has access to a clock to generate the timing necessary for the synchronization. The control circuitry 124 comprises a laser or LED drive circuit using for example a current or a voltage which drives electronic circuitry to drive the light source 24 at the predetermined pulse width. The control circuitry 124 also has access to a power supply (not shown) and logic for generating different voltage levels as needed. The control circuitry 124 may additionally or alternatively have access to the different voltage levels and logic for determining the timing and conductive paths to which to apply the different voltage levels for turning ON and OFF the respective image capture areas.

To acquire a 3D image of scene 130, control circuitry 124 controls light source 24 to emit a train of light pulses, schematically represented by a train 140 of square light pulses 141 having a pulse width, to illuminate scene 130. A train of light pulses is typically used because a light source may not provide sufficient energy in a single light pulse so that enough light is reflected by objects in the scene from the light pulse and back to the camera to provide satisfactory distance measurements to the objects. Intensity of the light pulses, and their number in a light pulse train, are set so that an amount of reflected light captured from all the light pulses in the train is sufficient to provide acceptable distance measurements to objects in the scene. Generally, the radiated light pulses are infrared (IR) or near infrared (NIR) light pulses.

During the gated period, the short capture period may have duration about equal to the pulse width. In one example, the short capture period may be 10-15 ns and the pulse width may be about 10 ns. The long capture period may be 30-45 ns in this example. In another example, the short capture period may be 20 ns, and the long capture period may be about 60 ns. These periods are by way of example only, and the time periods in embodiments may vary outside of these ranges and values.

Following a predetermined time lapse or delay, T, after a time of emission of each light pulse 141, control circuitry 124 turns ON or gates ON the respective image capture area of photosurface 300 based on whether a gated or ungated period is beginning For example, lines 304 and lines 305 may be included in the same set of alternating lines which forms one of the image capture areas. (See FIG. 7, for example). In another example, lines 304 and 305 may be in different lines sets, each line set forming a different image capture area. (See FIG. 4, for example). When the image capture area is gated ON, light sensitive or light sensing elements such as photopixels, capture light. The capture of light refers to receiving light and storing an electrical representation of it.

In one example, for each pulse of the gated period, the control circuitry 124 sets the short capture period to be the duration equal to the light pulse width. The light pulse width, short capture period duration, and a delay time T define a spatial “imaging slice” of scene 130 bounded by minimum and maximum boundary distances. The camera captures light reflected from the scene during gated capture periods only for objects of the scene located between the lower bound distance and the upper bound distance. During the ungated period, the camera tries to capture all the light reflected from the pulses by the scene that reaches the camera for normalization of the gated light image data.

Light reflected by objects in scene 130 from light pulses 141 is schematically represented by trains 145 of light pulses 146 for a few regions 131 and 132 of scene 130. The reflected light pulses 146 from objects in scene 130 located in the imaging slice are focused by the lens system 121 and imaged on light sensitive pixels (or photopixels) 302 of the gated ON area of the photosurface 300. Amounts of light from the reflected pulse trains 145 are imaged on photopixels 302 of photosurface 300 and stored during capture periods for use in determining distances to objects of scene 130 to provide a 3D image of the scene.

In this example, the control circuitry 124 is communicatively coupled to the processor 32 of the image capture device 20 to communicate messages related to frame timing and frame transfer. When a frame capture period ends, the stored image data captured by the photosurface 300 is readout to a frame buffer in memory 34 for further processing, such as for example by the processor 32 and computing environment 12 of the target recognition, analysis and tracking system 10 shown in FIG. 2.

FIG. 4 illustrates an example of a system for controlling an interline CCD photosurface 400 including at least two image capture areas as sets of alternating lines. This system may be used in the system illustrated in FIG. 3. In this embodiment, the CCD photosurface 400 includes light sensitive pixels or photopixels 402 aligned with storage pixels 403 in an linear array. In this example, the areas are an ungated capture area including odd numbered lines of photopixels 416 and their accompanying storage pixels 417, and a gated capture area including even numbered lines of photopixels 418 and their accompanying storage pixels 419.

The photopixels 402 sense light and during a capture period of the photosurface, light incident on the photosurface generates photocharge in the photopixels. The storage pixels are insensitive to light, and light incident on the photosurface does not generate photocharge in the storage pixels. Storage pixels are used to accumulate and store photocharge created in the photopixels during a capture period of the photosurface. In this embodiment, each line of storage pixels 403 can be considered a vertical register. The storage pixels 403 have access to a horizontal shift register 404 which serially reads out each line of storage pixels for transfer to the frame buffer 34.

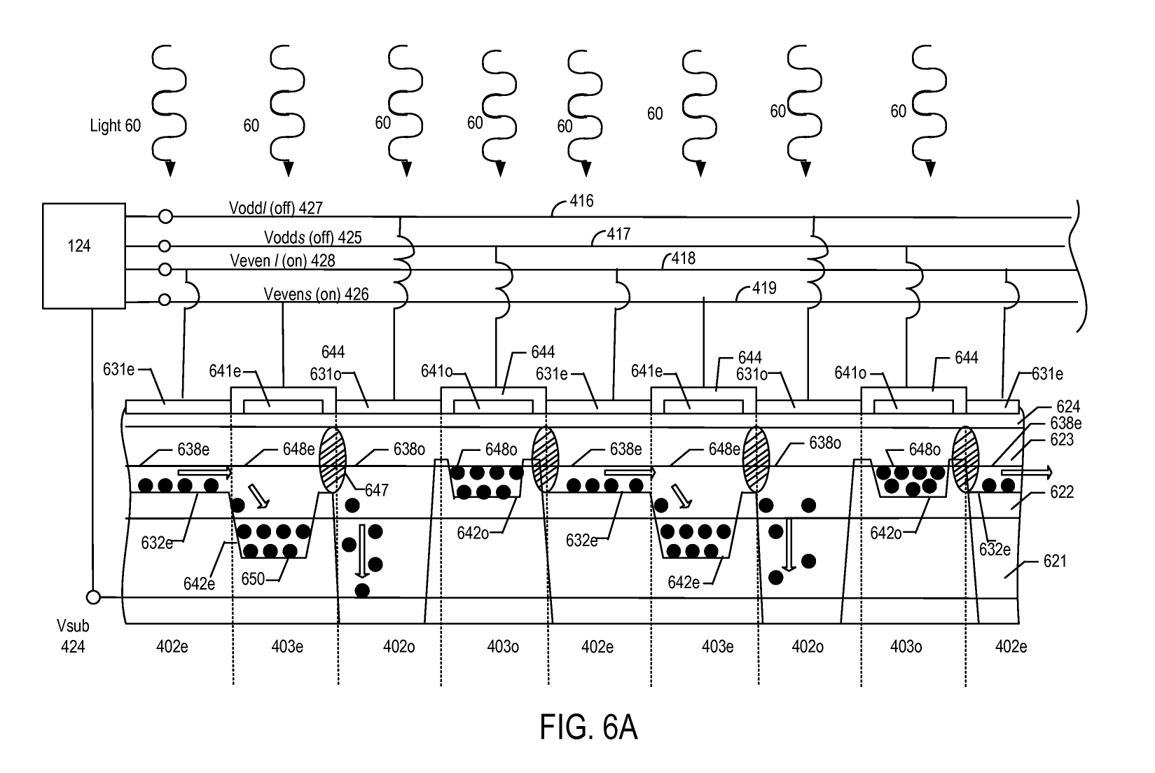

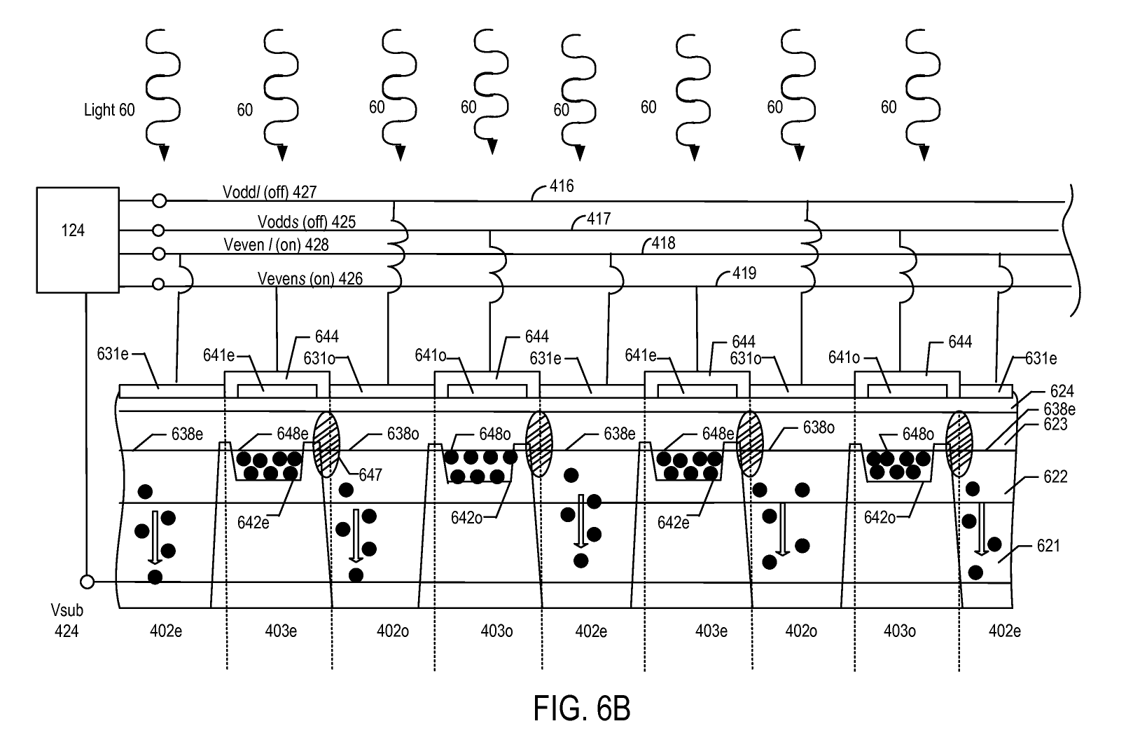

Each line of storage pixels, and each line of photopixels, comprises its own electrodes (see 631 and 641 in FIGS. 6A and 6B). Functioning of the photopixels and storage pixels is controlled by controlling voltage to their respective electrodes. Control circuitry 124 generates light pulses 141 with light source 24. The control circuitry 124 uses voltages in this example (e.g. Vevenl 428, Vevens 426, Voddl 427, Vodds 425, and Vsub 424) to cause one image capture area to capture reflected light from the pulses 141 during a gated period 422, and another image capture area to capture reflected light 146 from pulses 141 during an ungated capture period 420. In this embodiment, the control circuitry 124 controls a substrate voltage Vsub 424 for the semiconductor device, a voltage value Voddl 427 connected to the electrodes for photopixels in odd numbered lines, a voltage value Vodds 425 connected to the electrodes for storage pixels in odd numbered lines, a voltage value Vevenl 428 connected to the electrodes for photopixels in even numbered lines, and a voltage value Vevens 426 connected to the electrodes for storage pixels in even numbered lines. The control circuitry 124 can embody separate control areas for controlling the photosurface 400 and the light source 24, but the turning ON and OFF of capture ability of pixels in the photosurface should be synchronized to the emission of the light pulses for capturing the data for distance measurements.

FIG. 4 further shows gated capture periods 422 and ungated capture periods 420, each capturing reflected light 146 from light pulses 141. As seen within the exemplar ungated capture period 420, reflected light 146 from light pulse 141 has a relatively long capture period 410 in which to travel back to the CCD photosurface 400 along with light reflected from other sources such as background light. While for the exemplar gated capture period 422, the even numbered lines 418 and 419 have a comparatively short capture period 408 to capture light 146 reflected back to the photosurface from a light pulse 141 in the train 145. As mentioned above, for example, if a short capture period 408 is 20 nanoseconds (ns) for 20 ns pulse widths from a laser, the long capture period 410 can be 40 to 60 ns. In another example, if the short capture period 408 is 10-15 ns, the long capture period 410 is 20-45 ns. These capture periods are by way of example only, and may vary in further embodiments, with the provision that the long capture periods 410 in ungated capture periods 420 are sufficiently long to capture light suitable for normalizing light captured during short capture periods 408 or gates in the gated capture periods 422.

As many as a thousand light pulses or more might be required in a light pulse train so that an amount of reflected light that reaches the camera from the scene is sufficient to provide acceptable distance measurements in a frame. To reduce imaging time, and/or possible image blur to an acceptable level, the light pulse repetition rate, and corresponding repetition rate of capture periods, may advantageously be as high as at least 107 per second or more, and consequently have a repetition period of about 100 ns or less. Furthermore, light pulse widths and durations of short capture periods may be equal to about 30 ns or less. A typical frame rate of a motion capture camera is 30 frames a second, so the shorter the short and long capture periods, the more gated and ungated periods can be captured if the photosurface can turn on and off its image capture areas as quickly as well.

During each repeating short capture period in a gated period, pixels, both storage and photopixels, in even numbered lines of pixels are controlled to be in an “ON” state 412. During an ON state, the photopixels 402 transfer charge they accumulate to their respective storage pixels 403 in the photosurface 400. Pixels in odd numbered pixel rows are controlled to be in an “OFF” state during the entire gated period to inhibit the photopixels from transferring charge to their respective storage pixels in the photosurface. During each repeating long capture period in an ungated period, photopixels 402 in odd numbered rows are controlled to be in an “ON” state 414 in which they transfer charge they accumulate to their respective storage pixels 403. Pixels in even numbered rows are controlled to be in the OFF state, so as to inhibit charge transfer during the entire ungated period.

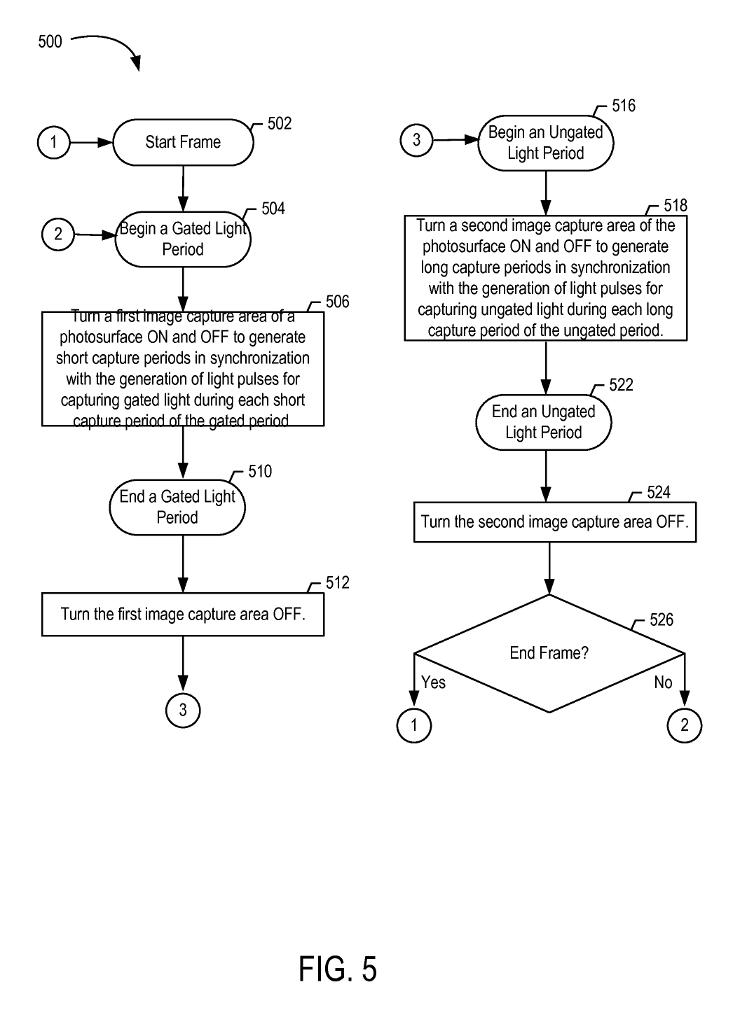

Different embodiments of a photosurface are discussed below which can be gated on and off for both a gated period and an ungated period in a same frame. Whichever type of technology, e.g. CCD or CMOS sensor (see FIG. 7), is used, either may use a method of operation such as the embodiment described in FIG. 5.

FIG. 5 is a flowchart of one embodiment of a method 500 for capturing interleaved gated and ungated light from a scene in a same frame period on the same photosurface. FIG. 5 is discussed in terms of the previous embodiments for illustrative purposes only and not to be limiting thereof. The method embodiment 500 begins in step 502 with a start of frame notification which control circuitry 124 can receive from the processor 32 of the capture device 20. In step 504, the control circuitry 124 begins a gated light period. In step 506, the control circuitry 124 turns a first image capture area of a photosurface ON and OFF to generate short capture periods in synchronization with the generation of light pulses for capturing gated light during each short capture period of the gated period within a frame period. As described previously for FIGS. 3 and 4, the control circuitry 124 controls the light source 24 as well as the different capture areas of the photosurface (300 or 400), and so the circuitry can provide control signals in synchronization. At the end of a gated period 422 in step 510, the control circuitry 124 in step 512 turns the first image capture area OFF. In some embodiments, the control circuitry 124 causes the transfer of captured image data from the first image capture area to a memory such as memory 34 of the capture device 20 at the end of the gated period. In other embodiments, the image data captured during the gated periods of the frame are transferred at the end of the frame to the frame buffer memory 34.

In step 516, an ungated period within the same frame period is begun by the control circuitry 124 which in step 518 turns a second image capture area of the photosurface ON and OFF to generate long capture periods in synchronization with the generation of light pulses for capturing ungated light during each long capture period of the ungated period.

For the end of the ungated light period in step 522, the control circuitry in step 524 turns the second image capture area OFF. Again in some embodiments, the control circuitry 124 causes transfer of the captured image data from the second image capture area to a memory such as memory 34 at the end of the ungated period. Again, in other embodiments, the image data captured during the ungated periods in the frame are transferred at the end of the frame to the frame buffer memory 34.

The control circuitry can determine in step 526 whether the end of the frame is occurring. This determination can be based on an interrupt signal from the processor 36 or the control circuitry can monitor a frame clock in another example. If the end of frame has not occurred, the control circuitry 124 proceeds with beginning another gated light period in step 504 again. If the end of frame has occurred, the control circuitry 124 proceeds with starting a new frame in step 502 and beginning the interleaving or alternating of gated and ungated periods again. For the start of a new frame, there can be some processing such as updating a frame number and the start of a frame clock in one example.

The interleaving of the gated and ungated periods begins with the gated period in the embodiment of FIG. 5, but the order can be reversed in other embodiments.

The embodiment of FIGS. 6A and 6B is discussed in the context of the embodiment of FIG. 4 for illustrative purposes only and is not intended to be limiting thereof. In the example of FIG. 6A, the current state of operation shown is during a short capture period of a gated period. For this example, the even numbered lines 402e, 403e are activated during the gated period, and the odd numbered lines of pixels 402o, 403o are turned OFF for the entire gated period. During an ungated period, the odd numbered lines of pixels 402o, 403o would be operated in the same fashion as for the even numbered lines of pixels. In another example, the odd numbered lines could have been the designated set used during a gated period, and the even numbered lines during an ungated period. For ease of description, reference to an “even” pixel means a storage or photopixel in an even numbered line, and reference to an “odd” pixel means a storage or photopixel in an odd numbered line.

FIG. 6A schematically shows a highly simplified cross-sectional view of a portion of one embodiment of an interline CCD photosurface 400. The portion shows two sets of representative photopixels and storage pixels as follows: photopixels 402e and 403e are of even numbered lines 418 and 419 respectively of the photosurface 400; and photopixels 402o and storage pixels 403o are of odd numbered lines 416 and 417 respectively. As indicated by the vertical dashed lines, each pixel of either type is composed of various layers within which the electrical characteristics and sizes of regions in the photosurface will change during operation. The dashed lines are not a precise demarcation between the pixels of different types but are intended to aid to viewer of the figure to identify regions of the photosurface associated with different pixels.

Interline CCD 400 is assumed, for convenience of presentation, to be configured with a doping architecture so that it captures electrons, hereinafter “photoelectrons”, rather than holes from electron-hole pairs generated by incident light. In other embodiments, the CCD 400 can be provided with a doping architecture that captures holes from electron-hole pairs generated by incident light.

In this example embodiment, the CCD photosurface 400 comprises a silicon p++ doped substrate 621, a p doped epitaxial layer 622, and an n doped layer 623. Layer 623 is covered with a silicon dioxide insulating layer 624. Conductive electrodes 631, polysilicon in this example, are formed over regions of the CCD photosurface that comprise photopixels 402 having np junctions 638. In this example, polysilicon electrodes 641 are also formed over regions of CCD 400 that comprise storage pixels 403 having np junctions 648. Light 60 propagating towards storage pixels 403 does not create photoelectrons in the storage pixels because the light is blocked from entering the storage pixels because the storage pixels are overlaid with a “masking” layer 644. An example of a material for the masking layer 644 is a metal, which is opaque to light 60 and blocks exposure of the regions under storage pixel electrode 641 to light 60. In some embodiments, electrodes 641 are formed from a conducting material that is opaque to light 60 and the electrodes provide masking of storage pixels 403 in place of masking layer 644, or enhance masking provided by the masking layer.

In this example, each photopixel 402 is associated with a storage pixel 403 on its right and is electrically isolated from a storage pixel 403 to its left. Isolation of a photopixel from the storage pixel 403 to its left can, for example, be achieved by implanting a suitable dopant, or by forming a shallow trench isolation region, schematically represented by shaded regions 647.

As will be discussed in specific examples below, generally, the photopixel electrodes 631 and storage pixel electrodes 641 are biased relative to each other so that when an ON voltage value is applied during a long or short capture period, photocharge generated in a photopixel by light from a scene rapidly transfers to and is accumulated and stored in the photopixel's storage pixel. When an OFF voltage value is applied to the photopixel electrode 631, photocharges generated in the photopixels by light from the scene drain to the substrate, and do not transfer from the photopixels and accumulate in the storage pixels. The bias of the photopixel electrode relative to the storage pixel electrode is maintained substantially the same for capture periods and non-capture periods of the photosurface.

The control circuitry 124 provides ON or OFF voltage values for Vevenl 428, Vevens 426, Voddl 427, and Vodds 425 on conductive paths (e.g. metal lines) to which the pixels are electrically connected. Even storage pixels 403e receive voltage Vevens 426 on path 419 while even photopixels 402e receive voltage Vevenl 428 on path 418. Similarly, odd storage pixels 403o receive voltage Vodds 425 on path 417 while odd photopixels 402o receive voltage Voddl 427 on path 416. The control circuitry 124 provides a reference voltage, Vsub 424, to the substrate 621 which will be used with the ON and OFF voltages to create potential voltage differences to bias the pixels as desired for storage and no storage of image data represented by photoelectrons or photocharges.

In FIG. 6A, even photopixels 402e are turned ON as are even storage pixels 403e for a short capture period within a gated period. Voltages Vsub 424, Vevenl 428 and Vevens 426 provide voltage differences which back bias np junctions 638e and 648e under electrodes 631e and 641e respectively in photopixels 402e and storage pixels 403e. The voltages generate respective potential wells 632e and 642e in the photopixels 402e and storage pixels 403e. Potential wells 642e under storage pixel electrodes 641e are deeper than potential wells 632e under photopixels electrodes 631e.

As a result of the difference in depth of potential wells 632e and 642e, electric fields are created between a photopixel 402e and its corresponding storage pixel 403e that drive, as indicated by the arrows, photoelectrons generated in the photopixel to the storage pixel. The doped regions 647 act as potential barriers to prevent electrons formed in a photopixel, e.g. 402e, from drifting to the left and into the left lying storage pixel, e.g. 403o. Photoelectrons, that are generated by light 60 incident on photopixels 402e are represented by shaded circles 650 and are continuously and rapidly transferred from the photopixel 402e and accumulated and stored in the photopixel's associated storage pixel 403e.

The fields cause photoelectrons 650 to transfer substantially immediately upon their creation in a photopixel 402e to its associated storage pixel 403e. A time it takes photocharge to transfer from a location in the photopixel at which it is generated to the storage pixel is determined by a drift velocity of the photocharge and a distance from the location at which it is generated to the storage pixel. The drift velocity is a function of the intensity of the fields operating on the photoelectrons, which intensity is a function of the potential difference between potential wells 632e and 642e. For typical potential differences of a few volts and pixel pitches of less than or equal to about 100 microns, photoelectrons transfer to a storage pixel in a time that may be less than or about equal to a couple of nanoseconds or less than or about equal to a nanosecond.

In one example for back biasing the np junctions 638e and 648e, Vsub 424 receives an ON voltage from control circuitry 124 which is received by the substrate layer 621. The electrodes 631 e for even photopixels 402e are electrified to an ON voltage for Vevenl 428 by the control circuitry 124 via conductive path 418. Vevenl 428 is more positive than Vsub. Electrodes 641e over storage pixels 403e are electrified to an ON voltage value for Vevens 426 via conductive path 419. Vevens 426 is substantially more positive than voltage Vsub 424. An example of an ON voltage for Vsub 424 is 10 volts with ON voltages for the even photopixels 402e of 15 volts and ON voltages for the even storage pixels 403e of 30 volts.

In FIG. 6A, the odd pixels 402o and 403o are in an OFF state in which image capture is inhibited. The odd photopixels 402o have a voltage difference between Vsub 424 and Voddl 427 which is sufficient to forward bias np junctions 638o in photopixels 402o. For example, if Vsub 424 is 10 volts, Voddl 427 may be 15 volts. However, a voltage difference between Vsub 424 and Vodds 425 is not sufficient to forward bias np junctions 648o in storage pixels 403o. For example, if Vsub 424 is 10 volts, then Vodds 425 may be set to 0 volts or negative 5 volts. As a result, whereas potential wells 642o in storage pixels 403o may be reduced in depth by the decreased voltage difference, they remain sufficiently deep to maintain photocharge they accumulated during the time that the odd storage pixels 403o were active during a previous ungated period of long capture periods. The forward biasing of the np junctions 638o of the odd photopixels drains charge from the photopixels, and photoelectrons generated by light 60 incident on the photopixels 402o stop moving to storage pixels 403o, but are attracted to and absorbed in substrate 621

For the odd pixels, whether the stored photoelectrons 650 for an ungated period are transferred for the frame data after each ungated period or after all the ungated periods in a frame period, the control circuitry 124 controls the voltage values Voddl 427 and Vodds 425 when the odd pixel lines are gated OFF for the entire gated period. For example, with a Vsub 424 set to 10 volts, Voddl 427 may be set to 15 volts and Vodds 425 may be set to 0 volts. If the photoelectrons 650 from each ungated period are accumulated and are all transferred once per frame, the Vodds 425 is sufficiently positive with respect to the current value of Vsub for the potential wells 642o to remain sufficiently deep to maintain photocharge they accumulated during the time that the odd numbered pixel lines 416 and 417 of the CCD 400 were gated ON.

If the photoelectrons 650 for each ungated period are transferred to a frame buffer after each ungated period of long capture periods, maintaining the accumulated charge during a gated period is not an issue.

In FIG. 6B, even storage pixels 403e are turned OFF for a period in between short capture periods within a gated period. In the OFF state, the even photopixels 402e and storage pixels 403e are in a same state as the odd photopixels 402o and storage pixels 403o. The photopixels 402e are draining to substrate 621, and the potential wells 642e are not accepting charges but are deep enough to maintain storage of photoelectrons 650 transferred by photopixels 402e during the previous short capture periods 408 of the gated period. In one example, the substrate voltage Vsub 424 has an OFF voltage which is made significantly more positive than an ON voltage for Vsub 424 resulting in the forward biased np junctions 638e discharging photoelectrons 650 through the substrate 621 while potential wells 642e of the storage pixels 403e of FIG. 6B are of a depth for maintaining storage of photoelectrons 650 but not accepting more of them. In this example, the voltages on the odd pixels 402o, 403o controlled by Voddl 427 and Vodds 425 on conductive paths 416 and 417 can be the same as the voltages Vevenl 428 and Vevens 426 on the conductive paths 418 and 419. An example of a Vsub 424 OFF voltage is 30 volts, and the voltage for Voddl 427, Vodds 425, Vevenl 428 and Vevens 426 is set to 15 volts.

In another example, Vsub 424 can be a reference voltage (e.g. 15 volts) maintained during both the gated and ungated periods, and the ON and OFF voltages on the odd and even pixels conductive paths can be changed to gate or turn ON and OFF the respective lines of pixels. To turn on the even pixels 402e, 403e for a short capture period 408, electrodes 631e for the even photopixels 402e are electrified with Vevenl 428 (e.g. 20 volts) which is more positive than Vsub 424 (e.g. 15 volts), and electrodes 641e for even storage pixels 403e are electrified to a voltage Vevens 426 (e.g. 30 volts), which is substantially more positive than voltage Vevenl 428.

During this same gated period, as mentioned above, the same Vsub 424 (e.g. 15 volts) is being applied to substrate 621 on which the odd photopixels and odd storage pixels are formed as well as the even ones. For the photopixels 402o and storage pixels 403o of the odd numbered lines, Voddl 427 may be the same (e.g. 20 volts) as Vevenl 428 or smaller if desired although it can be sufficient to forward bias np junctions 638o in odd photopixels 402o. However, Vodds 425 is set to a lower voltage value (e.g. 0 volts) than Vevens 426 (e.g. 30 volts) which generates smaller voltage differences which effect the size of the potential wells, particularly those 642o of the storage pixels 403o. The V odds 425 value is less positive than the ON value Vevens 426 is receiving, resulting in not forward biasing the np junctions 648o for the odd storage pixels 403o. The same voltage values Voddl 427 and Vodds 425 which keep the odd pixels in an OFF state during the gated period can be used for the voltage values Vevenl 428 and Vevens 426 for turning or gating OFF the even photopixels 402e and storage pixels 403e respectively for the periods in between short capture periods 408 in a gated period.

As mentioned above, the odd numbered lines of photopixels 402o and storage pixels 403o are OFF for the entire gated period, whether during short capture periods or in between them. So odd photopixels 402o receive the same voltage values to be OFF on Voddl 427 as the even photopixels receive on Vevenl 428 during the periods outside of the short capture periods 408 within a gated period 422. Similarly, Vodds 425 is the same as Vevens 426 during the periods outside of the short capture periods 408 within the gated period 422.

ON and OFF voltage values Voddl 427, Vodds 425, Vevenl 428, Vevens 426 on the odd (416, 417) and even (418, 419) voltage conductive paths can be changed rapidly so as to electronically shutter CCD 400. In particular, the shuttering is sufficiently rapid so that CCD 400 can be electronically gated fast enough for use in a gated 3D camera to measure distances to objects in a scene without having to have an additional external fast shutter. In one embodiment, the ON and OFF voltage values are switched to gate on the CCD for long (410) and short (408) capture periods having duration, less than or equal to 100 ns. Optionally, the short or long capture periods have duration less than or equal to 70 ns. In some embodiments, the short capture periods have duration less than 35 ns. In some embodiments, the short capture periods (408) have duration less than or equal to 20 ns.

It is noted that the practice of embodiments of the technology is not limited to interline CCD photosurfaces and cameras comprising interline CCD photosurfaces. For example, a photosurface may be based on CMOS technology rather than CCD technology.

FIG. 7 illustrates a system embodiment for controlling a CMOS photosurface 700 including two image capture areas, even and odd lines in this example, one for use during a gated period, and the other for use during an ungated period. In this example, separate lines of storage pixels are not needed. In one example, control and readout circuitry associated with each light sensitive CMOS pixel 702 can be within the area of the respective pixel of the semiconductor photosurface. In another example, control and readout circuitry for an entire line or area of pixels can be located in portions of lines of the photosurface. Other examples of CMOS layouts can also be used in further embodiments.

As in the CCD photosurface embodiment 400 of FIG. 4, control circuitry 124 controls the light source 24 to generate light pulses 141. In this embodiment, it additionally provides a source voltage Vdd 724 for the CMOS photosurface device 700, sets of even line voltages 728 via conductive path 718, and odd line voltages 727 via conductive path 716. The voltages are set to gate the appropriate set of lines during ungated or gated periods respectively. In this example, the odd pixel lines are active during the gated period 422 as indicated by ODD pixel lines ON 714, and the even pixel lines are active during an ungated period 420 as indicated by EVEN pixel lines ON 712. As noted previously, the odd numbered lines of pixels could have just as easily been designated for use during the ungated period and the even numbered lines of pixels designated for use during the gated period.

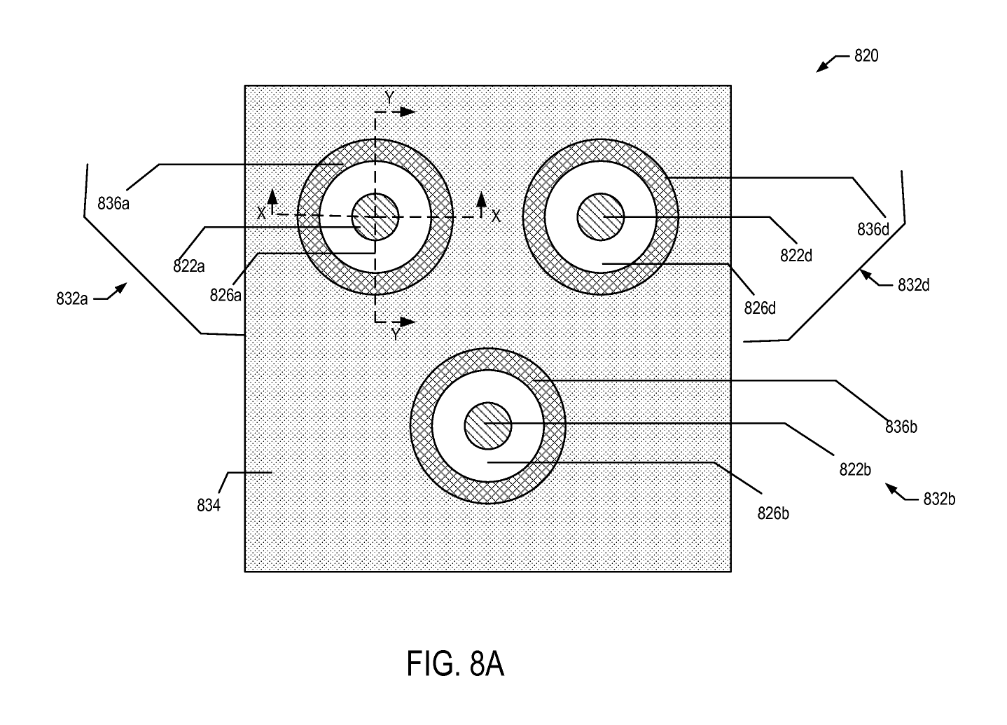

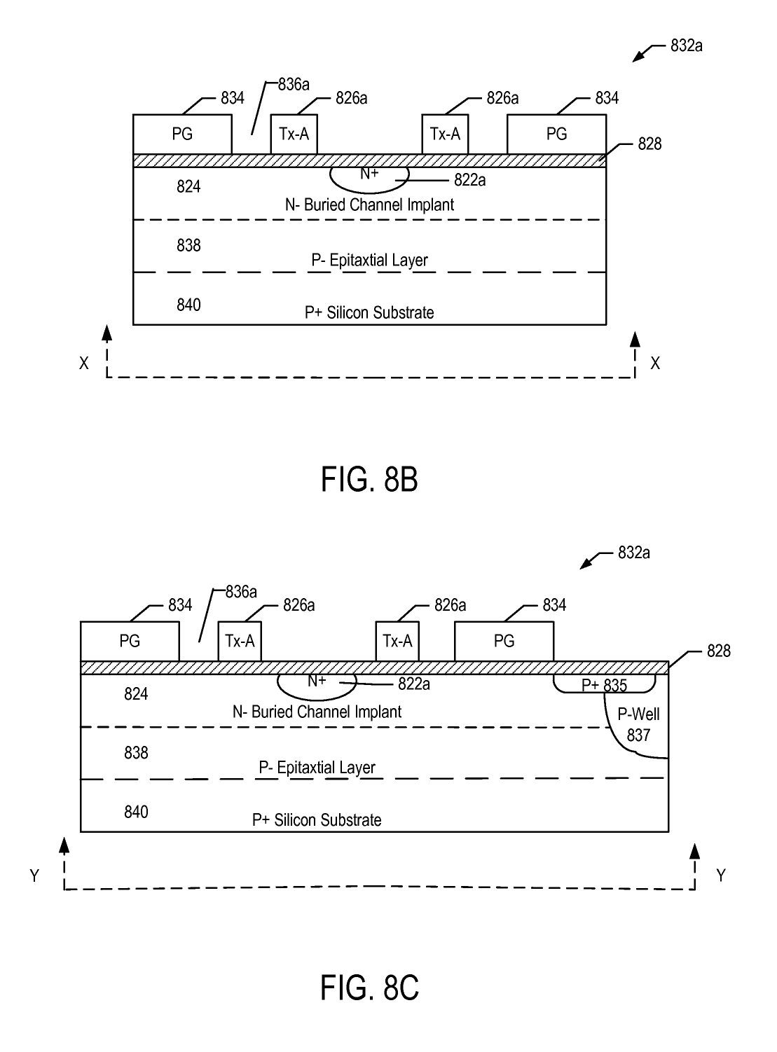

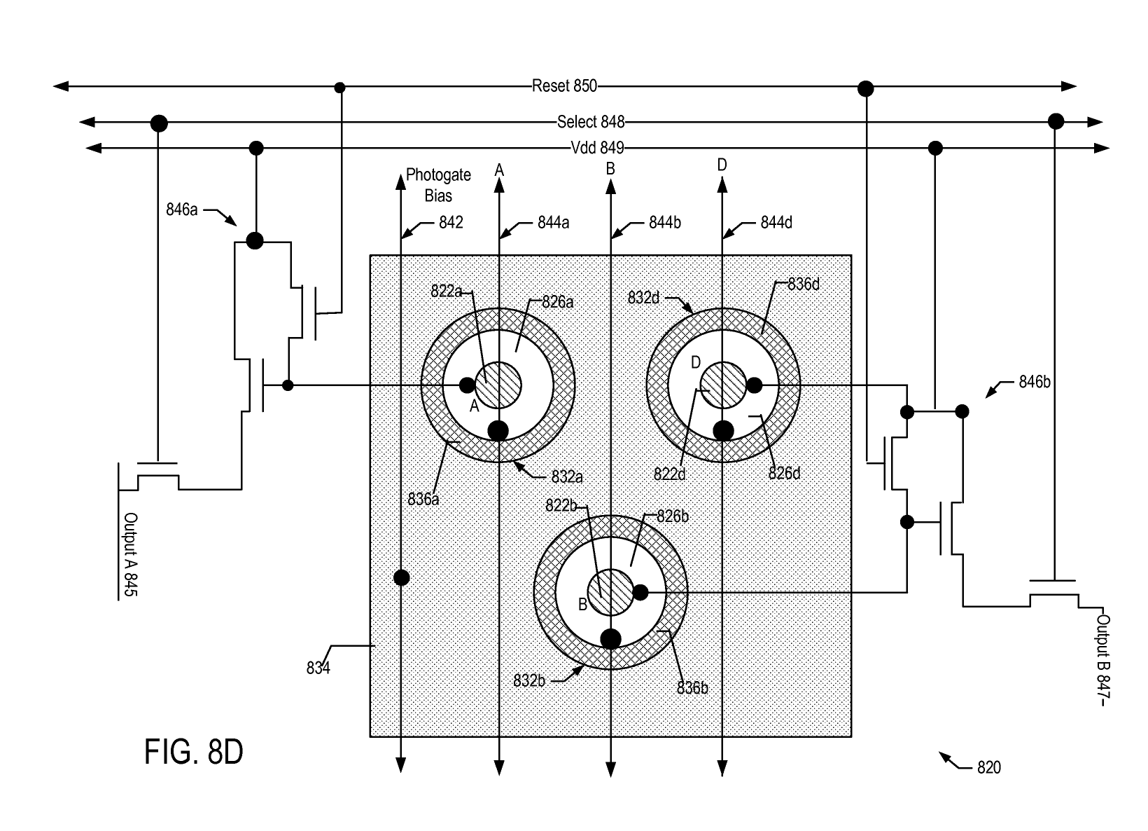

An example of a CMOS pixel technology which can be used in an embodiment such as that of FIG. 7 is shown in FIG. 8A which illustrates one embodiment 820 of a basic unit cell of a CMOS photogate technology. The basic unit cell 820 includes two floating diffusions 822a and 822b formed within a channel implant and which are surrounded by ring-like structures 826a and 826b which are their transfer gates and are referred to as transfer gate rings. The transfer gate need not be a ring, for example, it may be a hexagon or other surrounding shape, as long as the shape provides a substantially uniform 360 degree electric field distribution for charge transfer. The composite of a floating diffusion and its associated transfer gate ring is referred to hereafter as a “charge sensing element.”

In addition to the discussion of structure and operation of the basic unit cell 820 for the figures below, more information on this CMOS example can be found in, PCT Application PCT/IB2009/053113 entitled “CMOS Photogate 3D Camera System Having Improved Charge Sensing Cell and Pixel Geometry” filed on Jul. 17, 2009, which is hereby incorporated by reference.

According to PCT/IB2009/053113, photopixels formed of these cells are characterized by low capacitance, and consequently can provide improved sensitivity to small changes in charge accumulation. At the same time, the electric field created by the voltage applied to the photogate is substantially azimuthally symetric around the sensing element, and it has been found that electrons traveling from the charge accumulation region defined by the electrified photogate body through the channel to the floating diffusions experience substantially no obstructions as a function of travel direction. This can result in improved transfer characteristics.

Photopixels and pixel arrays formed of charge sensing elements also exhibit a substantially improved fill factor. Fill factors of 60 percent or more are achievable

FIG. 8A, in planar view, and FIGS. 8B and 8C in cross sectional views illustrate the architecture of the basic unit cell 820 from which, a type of photopixel, photogate pixels, are formed according to an embodiment of the technology. In the top view of FIG. 8A, unit cell 820 comprises three substantially circular N+ floating diffusions 822a, 822b, and 822d. Transfer gates 826a, 826b and 826d are in the form of rings surrounding diffusions 822a, 822b and 822d respectively.

Floating diffusion 822a and transfer gate 826a, and floating diffusion 822b and transfer gate 826b respectively form first and second charge sensing elements 832a and 832b. Floating diffusion 822d and transfer gate 826d form a background charge draining element 832d which provides background illumination cancellation. The transfer gates associated with the charge draining elements are energized during the intervals between emission of the illuminating pulses. In some embodiments, a background charge draining element 832d is not included. An output driver circuit can be used instead to perform background charge draining

Generally circular apertures 836a, 836b and 836d are aligned with charge sensing elements 832a and 832b and background charge draining element 832d. Apertures 836a, 836b and 836d provide a suitable clearance to expose these elements for convenient wiring access and to provide substantially uniform 360° electric field distribution for charge transfer. A polycrystalline silicon photogate 834 is also formed as a continuous generally planar layer covering substantially the entire area of the upper surface of cell 820.

FIG. 8B is a cross-sectional view of charge sensing element 832a across the X-X line in FIG. 8A, and FIG. 8C is a cross-sectional view of charge sensing element 832a across the Y-Y line in FIG. 8A. In connection with FIGS. 8B and 8C, it will be understood that only the geometry of charge sensing element 832a and photogate 834 is illustrated, but charge sensing element 832b and charge draining element 832d are essentially the same. It will also be understood that floating diffusions 822a and 822b are connected to suitable output circuitry (not shown) and floating diffusion 822d is connected to the drain bias potential Vdd. (In the figures, draining elements are also labeled “D” and charge sensing elements by “A” and “B”) In this embodiment, the basic structure of the portions of unit cell 820, other than charge sensing elements 832a and 832b, background charge draining element 832d, and photogate 834, may be of conventional CMOS constructions. The unit comprises, e.g., an N− buried channel implant 824, on top of a P− epitaxial layer 838 which is layered above a P+ silicon substrate 840, along with the required metal drain and source planes and wiring (not shown). Alternatively, any other suitable and desired architecture may be employed.

Polycrystalline silicon transfer gate 826a is located on an oxide layer 828 formed on the N⁻ buried channel implant layer 824. A polycrystalline silicon photogate 834 is also formed on oxide layer 828 as a continuous generally planar layer covering substantially the entire area of the upper surface of cell 820. As mentioned above, aperture 836a provides substantially uniform 360° electric field distribution for charge transfer through the channel implant layer 824.

Substantially circular N+floating diffusion 822a is formed within the N⁻ buried channel implant 824. Polycrystalline silicon ring-like transfer gate 826a is located on the oxide layer 828. The floating diffusions are located within the buried channel implant 824, and therefore the “surrounding” transfer gates, which are above the oxide layer, form what may be regarded as a “halo”, rather than a demarcating border. For simplicity, however, the term “surrounding” will be used in reference to the charge sensing cell arrangement.

In operation, photogate 834 is energized by application of a suitable voltage at a known time in relation to the outgoing illumination, for example light pulses 141 in FIG. 3, and is kept energized for a set charge collection interval. The electric field resulting from the voltage applied to photogate 834 creates a charge accumulation region in the buried channel implant layer 824, and photons reflected from the subject being imaged pass through the photogate 834 into the channel implant layer 824, can cause electrons to be released there.

Ring-like transfer gate 826a is then energized in turn for a predetermined integration interval during which collected charge is transferred to the floating diffusion 822a through the channel 824. This charge induces voltages that can be measured and used to determine the distance to the portion of the subject imaged by the pixel 702. The time of flight is then determined from the charge-induced voltage on the floating diffusion 822a, the known activation of timing of the photogate 834 and the transfer gate 826a, and the speed of light. Thus, the floating diffusion 822a is the sensing node of a CMOS photogate sensing pixel.

FIG. 8C further shows a stop channel structure or “channel stop” comprising a P diffusion area 835 formed in the channel layer 824 below the oxide layer 828 and overlapping the top of a P-Well 837. Charge transferred from the end of the channel 824 farthest from an activated transfer gate can be uncontrolled and noisy if the channel is not sharply terminated. The channel stop provides a well-defined termination at the end of the channel layer 824 to help promote controlled charge transfer to the floating diffusion 822a.

FIG. 8D illustrates an example of cell control and readout circuitry for use with a basic unit cell. Other conventional CMOS control and readout circuitry designs can be used as well. Signal paths for photogate bias 842, transfer gate A 844a, and transfer gate B 844b energize respectively the photogate 834 and transfer gates A and B (e.g. 826a and 826b in FIG. 8A).

The output circuit 846a and the output circuit 846b respectively provide readout voltages of output A 845 and output B 847 of the charge-induced voltages on floating diffusions 822a and 822b of the respective charge sensing elements 832a and 832b. These readout circuits 846a, 846b can be formed on an integrated circuit chip with the basic unit cell 820. Select 848 and reset 850 signal paths are provided for the output circuits 846a and 846b.

In systems employing pulsed illumination, background illumination may result in charge accumulation in the sensing cells 832a, 832b during the intervals between illumination pulses. Draining such charge accumulation between illumination pulses can be advantageous. For more information on the use of background illumination cancellation for TOF camera pixel cells, see Kawahito et al., A CMOS Time-of-Flight Range Image Sensor, IEEE Sensors Journal, December 2007, p.1578. Floating diffusion 822d is connected to Vdd 849 to provide a discharge path, and signal path D 844d energizes transfer gate D (e.g. 826d in FIG. 8B) during intervals between emission of the illuminating pulses to activate discharge of accumulation of charges.

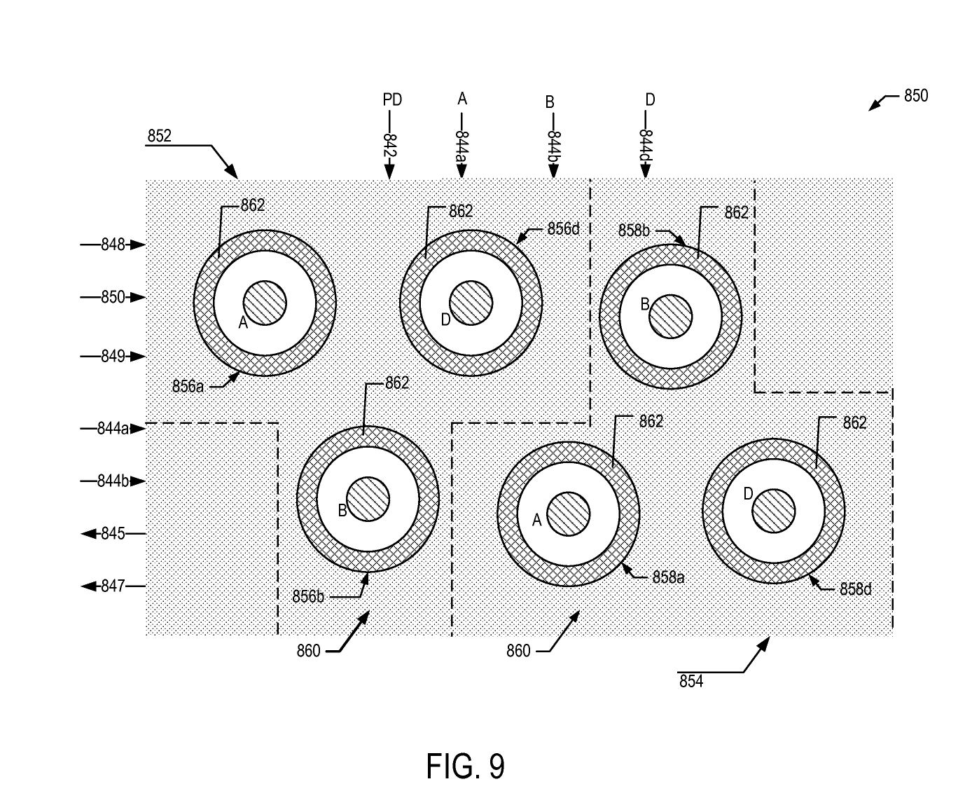

Basic unit cells 180 can be combined as needed to provide the light-gathering capability for a particular application. FIG. 9 is a schematic illustration of an embodiment of a basic photopixel building block comprising two basic unit cells. Gate control and readout circuitry, and other conventional features are omitted in the interest of clarity.

FIG. 9 illustrates an embodiment of a basic multi-cell building block 850 comprising two basic cells 852 and 854 as demarcated by dashed lines. Cell 852 includes sensing elements 856a and 856b, and background charge draining element 856d. Cell 854 includes sensing elements 858a and 858b, and background charge draining element 858d. As may be seen, building block 850 is formed with a single continuous photogate 860 with apertures 862 exposing the charge sensing and background charge draining elements.

According to PCT Application PCT/IB2009/053113, based on simulation studies performed by the inventors thereof, and assuming maximum gate excitation of 3.3v, 0.18 micron CMOS fabrication technology, and 70 Angstrom gate oxide thickness, it has been determined that suitable approximate cell component dimensions may be in the following ranges: Photogate perforation spacing (channel length) 1.0-6.0 μ (e.g., 3.0 μ); Transfer gate annular width: 0.3-1.0 μm (e.g., 0.6 μm); Photogate perforation to transfer gate clearance: 0.25-0.4 μm (e.g., 0.25 μm) Diameter of floating diffusion: 0.6-1.5 μm (e.g., 0.6 μm). It should be understood, however, that suitable dimensions may depend of applications, advancements in fabrication technology, and other factors, as will be apparent to persons skilled in the art, and that the above-stated parameters are not intended to be limiting.

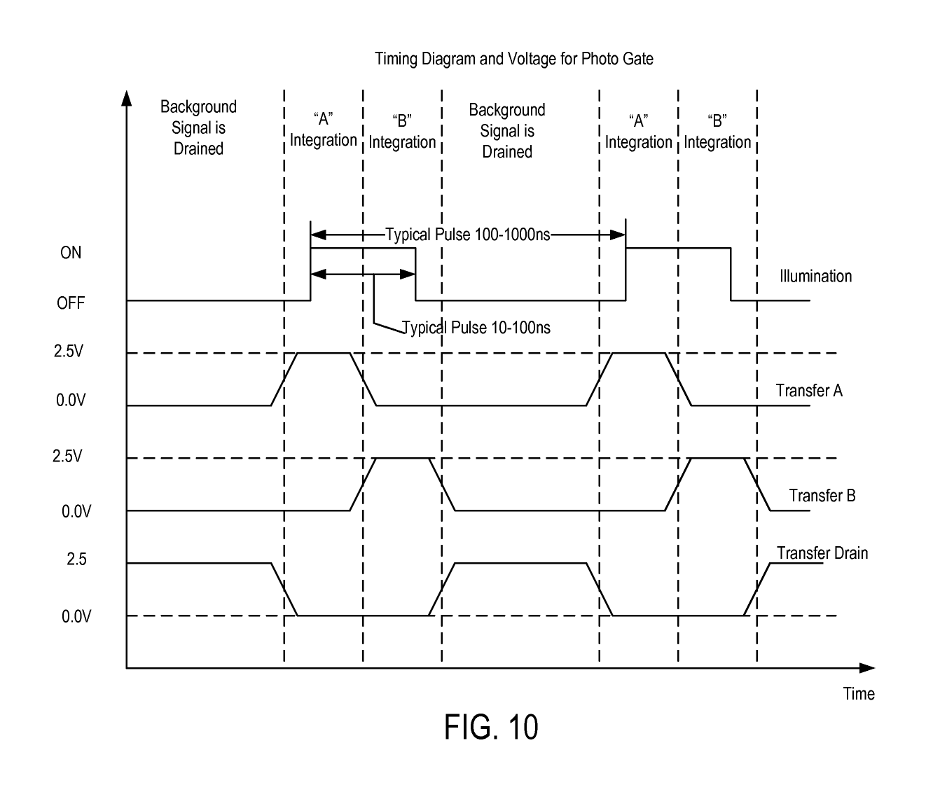

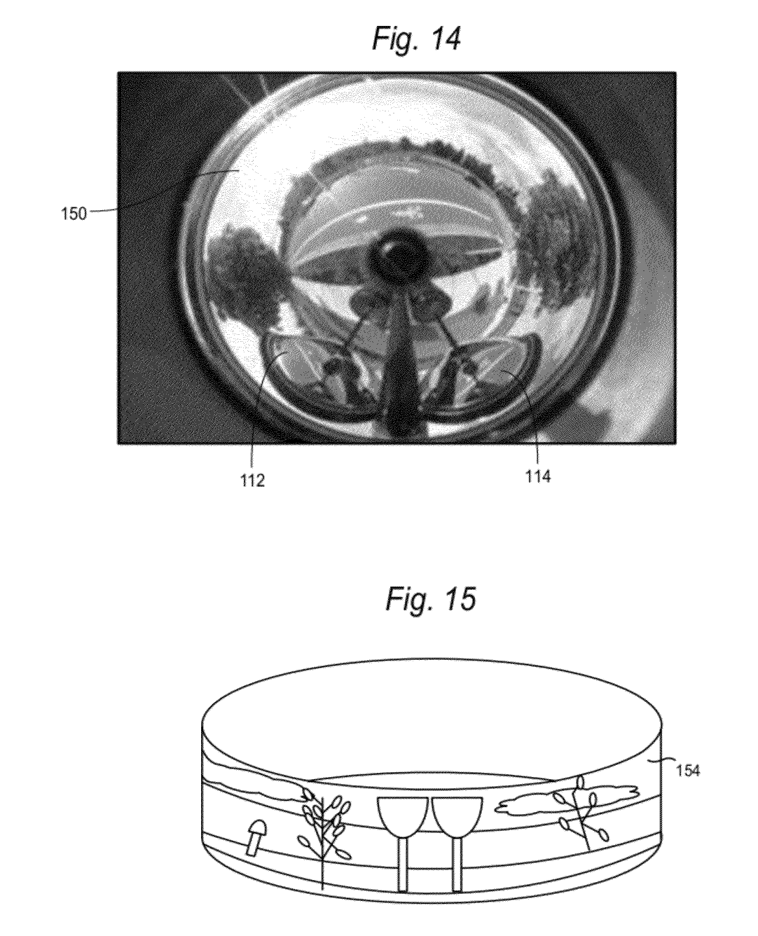

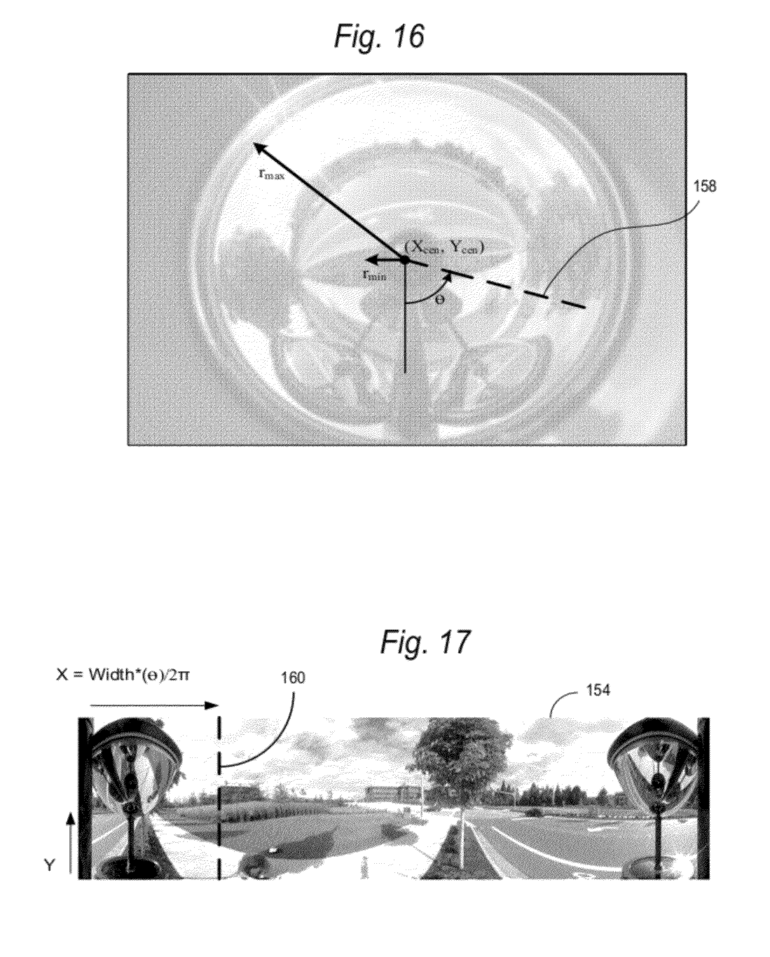

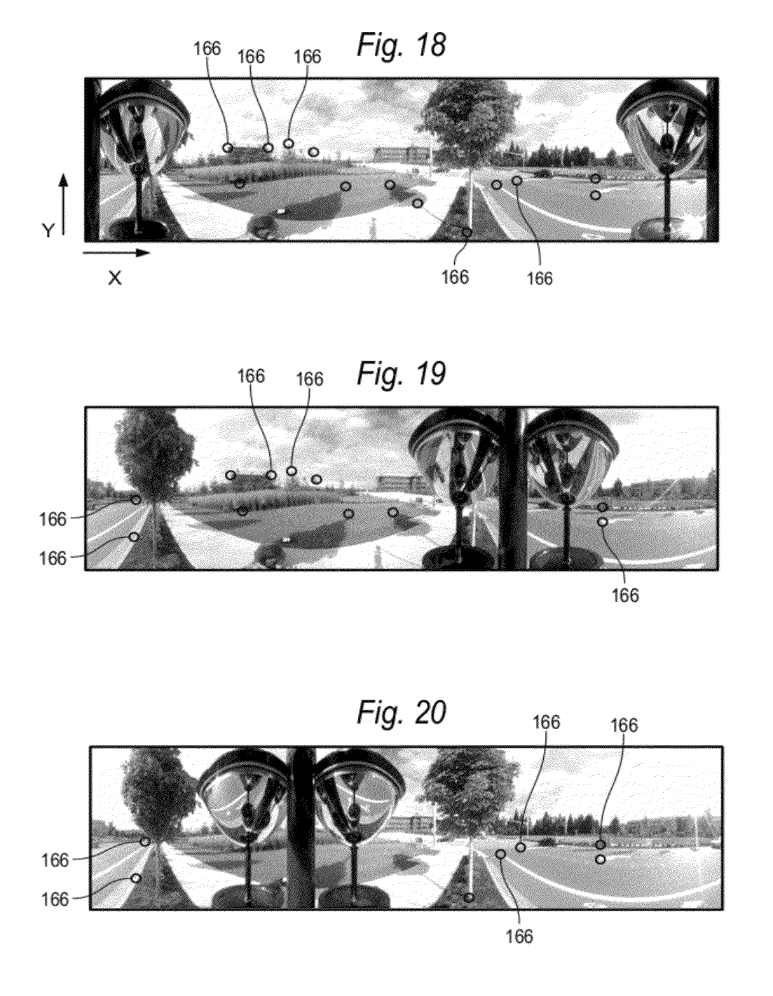

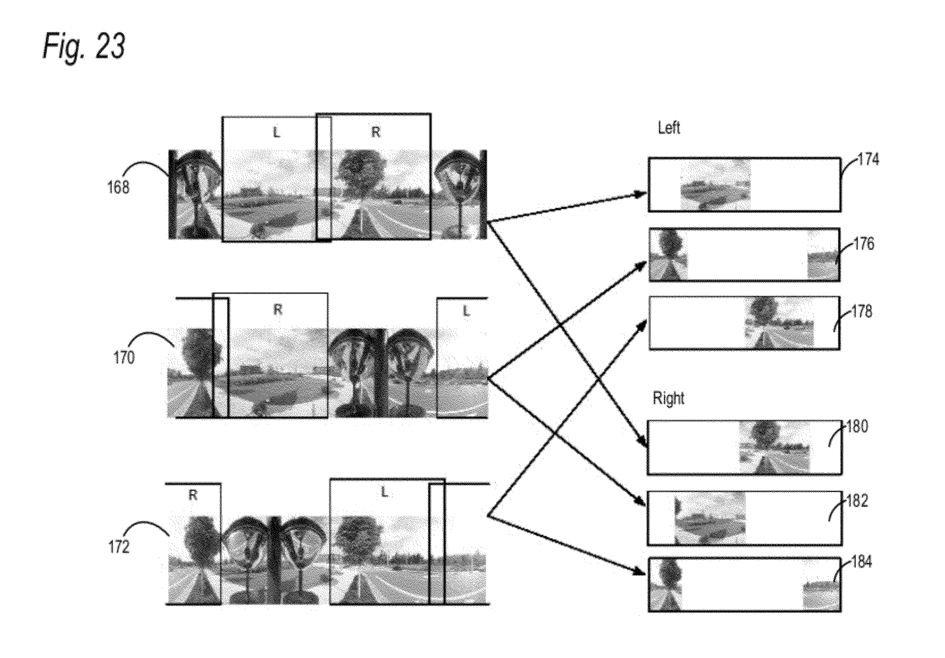

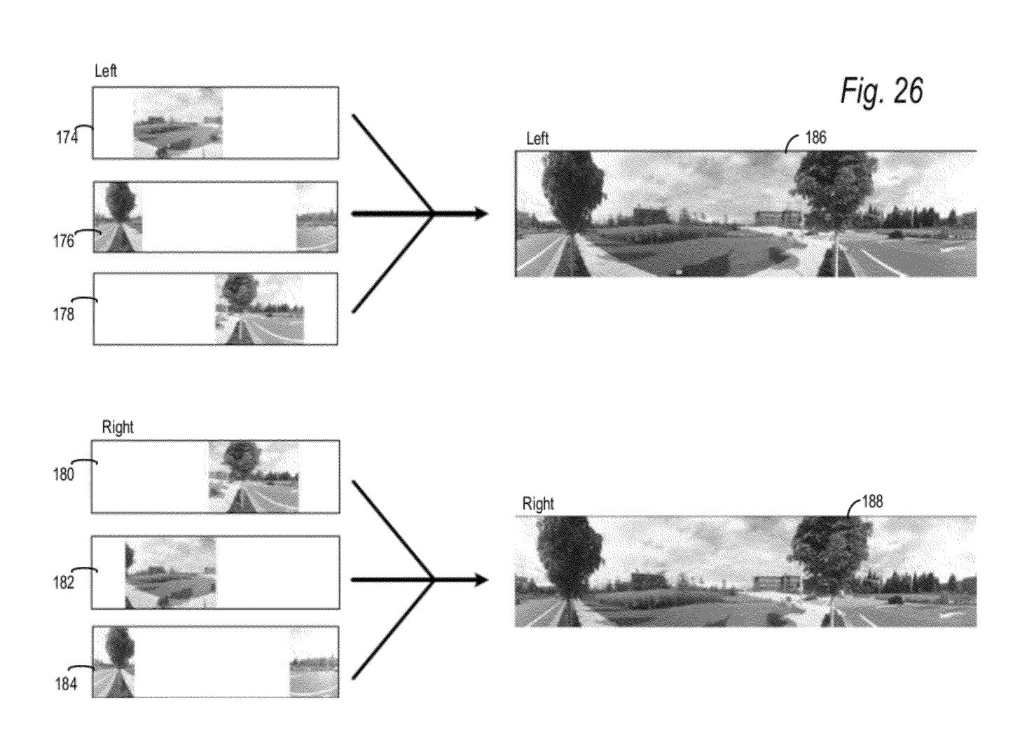

FIG. 10 is an exemplary timing diagram for a basic unit cell as described herein which provides background cancellation using a separate background charge draining element. Line (a) shows the illumination cycle. Lines (b) and (c) show the integration times for the “A” and “B” floating diffusions in the nanosecond range, and defined by the activation times for the respective “A” and “B” transfer gates. Line (d) shows the background cancellation interval, as defined by the activation time for the charge draining element transfer gate. The timing illustrated in FIG. 10 is also applicable to operation without background cancellation, or for embodiments in which the charge sensing element transfer gates and/or the photogate are used to activate background charge draining.

The technology can also operate in photosurface embodiments that may have a non-linear structure different from that of an interline CCD or CMOS photosurface. Other configurations or geometries of imaging areas can also be used. For example, columns instead of rows could have been used. Depending on the arrangement of control and readout circuitry, every other pixel can be in one set and the other pixels in another set. In addition, more than two imaging areas can be designated if desired.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for controlling a photosurface to capture gated and ungated light from a scene in a same frame period comprising:
a photosurface of an image sensor;
a first image capture area of the photosurface;
a second image capture area of the same photosurface;
control circuitry for controlling capture by the first image capture area of gated light as image data during a gated period within the frame period;
the second image capture area being in an OFF state in which image data is not captured during the gated period;
the control circuitry controlling capture by the second image capture area of ungated light as image data during an ungated period within the same frame period; and
the first image capture area being in an OFF state in which image data is not captured during the ungated period.

2. The system of claim 1 wherein the gated and ungated periods are interleaved during the same frame period.

3. The system of claim 2 further comprising:
the gated period comprises one or more short capture periods, each short capture period lasting about a pulse width of a light pulse which is less than 100 nanoseconds;
the control circuitry for controlling capture by the first image capture area by gating the first image capture area between an ON state in which image data is captured for each short capture period and the OFF state in which image data is not captured;
the ungated period comprises one or more long capture periods, each long capture period being longer than each short capture period to capture more reflected light from a scene for normalization of the image data captured during the gated period, each long capture period lasting less than 100 nanoseconds; and
the control circuitry controlling capture by the second image capture area by gating the second image capture area between the ON state for each long capture period and the OFF state.

4. The system of claim 1 wherein the photosurface is an interline photosurface comprising lines of photopixels.

5. The system of claim 1 wherein the photosurface is one of the group consisting of:
a charge coupled device (CCD); or
a complementary metal oxide silicon (CMOS) device.

6. The system of claim 4 wherein the first image capture area comprises an area of alternating lines of pixels, and the second image capture area comprises an area of different alternating lines of pixels.

7. The system of claim 3 further comprising
one or more image data storage media;
the control circuitry controlling capture by the first image capture area of gated light during a gated period includes storing image data from light received during short capture periods by the first image capture area in the one or more image data storage media during the same gated period; and
the control circuitry controlling capture by the second image capture area of ungated light as image data during an ungated period includes storing image data from light received during long capture periods by the second image capture area in the one or more image data storage media during the same ungated period.

8. The system of claim 7, wherein:
the gated period is about 10 microseconds and the ungated period is about 10 microseconds.

9. The system of claim 7 wherein each of the image capture areas includes light sensitive photo pixels and the one or more image data storage media include a storage pixel associated with each of the photo pixels.

10. The system of claim 7 wherein each of the image capture areas includes light sensitive photo pixels and the one or more image data storage media include CMOS transistors for storing voltages representing image data.

11. A method for capturing interleaved gated and ungated light from a scene in a same frame period on the same photosurface comprising:
capturing gated light as image data during a gated period within the frame period by a first image capture area of a photosurface of an image sensor;
capturing ungated light as image data during an ungated period within the same frame period by a second image capture area of the same photosurface;
turning the second image capture area to an OFF state in which image data is not captured by the second image capture area for the gated period;
turning the first image capture area to an OFF state in which image data is not captured by the first image capture area for the ungated period; and
alternating the capturing gated light and the capturing ungated light on the same photosurface within in less than 2 microseconds.

12. The method of claim 11 further comprising:
the gated period comprises one or more short capture periods, each short capture period being less than 50 nanoseconds in duration;
the capturing gated light as image data during a gated period within the frame period by a first image capture area comprises gating the first image capture area between an ON state for each short capture period in which image data is captured and the OFF state in which image data is not captured;
the ungated period comprises one or more long capture periods, each long capture period being longer than each short capture period and less than 100 nanoseconds in duration; and
the capturing ungated light as image data during an ungated period within the same frame period by a second image capture area comprises gating the second image capture area between the ON state for each long capture period and the OFF state.

13. The method of claim 11 wherein
capturing gated light as image data during a gated period within the frame period by a first image capture area further comprises storing image data in image storage media associated with the first image capture area for the one or more short capture periods during each gated period of the frame; and
capturing ungated light as image data during the ungated period within the frame period by the second image capture area further comprises storing image data in image storage media associated with the second image capture area for the one or more long capture periods during each ungated period of the frame.

14. In a three-dimensional (3D) time of flight camera system, a system for controlling a photosurface to capture gated and ungated light from a scene in a same frame period, the system comprising:
the same photosurface comprising a first image capture area comprising a first set of lines of photopixels and image data storage media for capturing gated light as image data during a gated period within the frame period and a second image capture area comprising a second set of lines of photopixels and image data storage media for capturing ungated light as image data during an ungated period within the same frame period; and
control circuitry electrically connected to the image capture areas for
causing storage of image data sensed by the first set of lines of photopixels to respective image data storage media of the first capture area during the gated period,
causing the second image capture area to be in an OFF state in which image data is not stored in the respective image data storage media for the second set of lines of photopixels for the entire gated period,
causing storage of image data sensed by the second set of lines of photopixels to respective image data storage media of the second capture area during the ungated period, and
causing the first image capture area to be in the OFF state in which image data is not stored in the respective image data storage media for the first set of lines of photopixels for the entire ungated period.

15. The system of claim 14 wherein the gated and ungated periods are interleaved during the same frame period.

16. The system of claim 15 further comprising:
the gated period comprises one or more short capture periods, each short capture period being of less than 100 nanoseconds;
the causing storage of image data sensed by the first set of lines of photopixels to respective image data storage media of the first capture area during the gated period comprises storing image data captured during each short capture period;
the ungated period comprises one or more long capture periods, each long capture period being longer than each short capture period and less than 100 nanoseconds in duration; and
the causing storage of image data sensed by the second set of lines of photopixels to respective image data storage media of the second capture area during the ungated period comprises storing image data captured during each long capture period.

17. The system of claim 16 wherein the interline photosurface is a CMOS sensor.

18. The system of claim 16 further comprising:
the image data storage media are storage pixels, each storage pixel storing image data for one of the photopixels;
each pixel including an electrode and sharing a substrate of the photosurface;
the control circuitry generating a voltage difference across the substrate and electrodes of pixels of the first set of lines during the gated period for causing storage of image data by the storage pixels of the first set and generating a voltage difference across the substrate and electrodes of pixels of the second set of lines during the gated period for inhibiting storage of image data by storage pixels of the second set during the gated period by the second set of lines; and
the control circuitry generating a voltage difference across the substrate and electrodes of pixels of the second set of lines during the ungated period for causing storage of image data by the storage pixels of the second set and generating a voltage difference across the substrate and electrodes of pixels of the first set of lines during the ungated period for inhibiting storage of image data by the storage pixels of the first set during the ungated period by the first set of lines.

19. The system of claim 18 wherein the photosurface is an interline photosurface.

20. The system of claim 19 wherein the interline photosurface is a charge coupled device (CCD) sensor.
